(19) United States
(12) Patent Application Publication
(10) Pub. No.: US 2007/0190277 A1
(43) Pub. Date: Aug. 16, 2007

(54) Sterilisible Composite Film

(76) Inventors: Wilfried Jud, Singen (DE); Hans-Rudolf Nageli, Neuhausen (CH)

Correspondence Address: FISHER, CHRISTEN & SABOL, 1725 K STREET, N.W., SUITE 1108, WASHINGTON, DC, 20006, US

(21) Appl. No.: 11/730,534

(22) Filed: Apr. 2, 2007

Related U.S. Application Data
(63) Continuation of application No. 09/505,713, filed on Feb. 17, 2000.

(30) Foreign Application Priority Data
Jun. 15, 1999 (CH) 1114/1999

(51) Int. Cl. B32B 15/088; B32B 15/085; B32B 15/09; B32B 1/02

(52) U.S. Cl. 428/35.9; 428/457; 428/523; 428/480; 428/474.4; 428/458; 428/461

(57) ABSTRACT

Sterilisible composite film for manufacturing pouch type forms of packaging and the like for e.g. liquid, pasty or solid foodstuffs. The sterilisible composite films according to the present invention contain a barrier layer that is impermeable to water vapour and gases in the form of a metal foil. On both sides of the barrier layer is at least one functional layer. The following layers are arranged on top of each other in the composite film: a) a first functional layer containing a plastic film of the polyamide or polyolefin type or an extrusion layer of polyolefins or one or more lacquer layers or print and lacquer layers or print layers and b) a metal foil and c) a second functional layer in the form of a plastic film of coextrusion coated, co-extruded or extrusion laminated polyamide/polypropylene type layers, such as e.g. a film contain-ing polyamide/polypropylene layers or containing polypropylene/polyamide/poly-propylene layers.

The present invention relates to a sterilisible composite film containing a barrier layer that is impermeable for water vapour and gases, comprising a metal foil and on both sides of the barrier layer at least one functional layer; the invention also embraces the use of the composite film.

Known are sterilisible composite films, e.g. those employed in the manufacture of pouches for packaging foodstuffs for human and animal consumption. For example composites of plastic films or plastic laminates and a barrier layer impervious to water vapour and gases in the form of a metal foil are processed into pouches by stamping or cutting and/or folding and sealing. Exemplary for such a composite film is a four layer composite containing one after another e.g. a polyester film, an aluminium foil, an oriented polyamide film and a polypropylene film. The polyester film provides the strength, the polyamide film acts supportively in the composite and the generally relatively thick polypropylene film improves the resistance to penetration and can be sealed. Each of the four layers is joined to the neighbouring layers by means of an adhesive and, in some cases by an additional bonding agent and/or primer.

Manufacturing such a composite is complicated as the various process steps may have to be carried out in different facilities. Depending on the number and type of layers it necessary to employ a corresponding number of passes through the machine. As a result of the many layers of adhesive, delamination may readily occur under the conditions required for sterilis-ation.

The object of the present invention is to propose a composite film which has a simple structure or a structure that can be manufactured by simple technology, can withstand sterilisation conditions and can be easily processed into pouches.

That objective is achieved by way of the invention in that the composite film exhibits a layer structure containing one over the other or one after the other:
a) a first functional layer containing a plastic film of the polyester, polyamide or poly-olefin type or an extrusion layer of polyolefins or one or more lacquer layers or print and lacquer layers or print layers and
b) a metal foil and
c) a second functional layer in the form of a plastic film of the coextrusion coated, coextruded and/or extrusion laminated polyamide/polypropylene film type.

Preferred are sterilisible composite films that exhibit a layer structure containing one after the other:
a) a plastic film of the polyester type and
b) a metal foil and
c) a plastic film of the coextrusion coated, coextruded and/or extrusion laminated polyamide/polypropylene type of film.

Further preferred sterilisible composite films according to the present invention are such containing one after the other:
a) one or more lacquer layers or print and lacquer layers or print layers and
b) a metal foil and
c) a plastic film of the coextrusion coated, coextruded and/or extrusion laminated polyamide/polypropylene type of film.

The metal foils may have a thickness e.g. of 5 to 100 μm, usefully from 7 to 25 μm and preferably from 7 to 15 μm.

The metal foil may be of steel, iron or copper and is preferably an aluminium foil. The aluminium foil may be of pure aluminium or usefully an aluminium alloy of the type AlMn, AlFeMn, such as AlFe1.5Mn, AlFeSi or AlFeSiMn, for example having a purity of 97.5% and higher, preferably 98.5% and higher. The metal foil is preferably an uninterrupted foil, which should also be texture free and homogeneous.

The metal foil or aluminium foil is either not pre-treated with a primer or is e.g. pre-treated with a primer on one or both sides.

Suitable primers may e.g. be chosen from the epoxy resin or polyurethane series.

In the case of plastic films of the polyester type this may be a monofilm or a composite film of two or more layers. The plastic films of the polyester type may be non-stretched or may be uniaxially or biaxially stretched. The plastic films of the polyester type may have a thickness e.g. of 8 to 25 μm, usefully 10 to 18 μm and preferably 12 μm.

Examples of polyester type films are polyalkylene-terephthalates or polyalkylene-iso-phthalates with alkylene groups or radicals with 2 to 10 carbon atoms or alkylene groups with 2 to 10 C atoms that are interrupted e.g. by one or two —O—, such as e.g. polyethylene-terephthalate (PET films), polypropylene-terephthalate, polybutylene-terephthalate (poly-tetramethylene-terephthalate), polydecamethylene-terephthalate, poly-1,4-cyclohexyl-di-methylole-terephthalate or polyethylene-2,6-napthalene-dicarboxylate or mixed polymers of polyaklylene-terephthalate and polyalkylene-isophthalate, where the fraction of isophthalate amounts e.g. to 1 to 10 mol %, mixed polymers and terpolyrmers, also block polymers and grafted modifications of the above mentioned substances. Other useful polymers are known in the field under the abbreviation PEN.

Other polyesters are copolymers of terephthalic acid and a further polycarboxyl acid with at least one glycol. Useful in that respect are the copolymers of terephthalic acid, ethylene glycol and a further glycol. Preferred are glycol-modified polyesters known in the field as PETG.

Further preferred polyesters are polyalkylene-terephthalates with alkylene groups or radicals with 2 to 4 carbon atoms. Belonging to these polyalkylene-terephthalates are also A-PET, PETP and the so-called PETG or G-PET. Very highly preferred are polyalkylene-terephthalate films of the PETP type. The films of polyester may be non-stretched or uniaxially or, preferably, biaxially oriented.

The plastic films of the polyolefin series may be a monofilm or a composite film made up of two or more layers. The plastic films of the polyolefin series may be non-stretched, uniaxially or biaxially oriented. The plastic films of the polyolefin series may exhibit a thickness of 8 to 30 μm, usefully 10 to 23 μm, preferably from 12 to 18 μm.

The extrusion layers of polyolefins may be an extrusion layer or a co-extrusion layer. The weight per unit area of the extrusion layer or co-extrusion layer may be e.g. from 3 to 25 g/m², preferably from 10 to 20 g/m².

Examples of polyolefins for the films or extrusion coatings are polyethylenes such as low, medium or high density polyethylenes or linear polyethylenes of low, medium or high density, special preference being given to high density polyethylenes. Further examples are co-polymers or terpolymers of ethylene with acrylic acid (EAA, ethyl acrylic acid), of ethylene acrylic esters such as methyl acrylate (EMA), ethyl acrylate (EEA) or butyl acrylate (EnBA), of ethylene with vinyl acetates (EVA), of ethylene with methacrylic arid (EMMA) or of ethylene with ethyl acrylate and acrylic acid (EAEAA) or ionomer resins. Further examples of a polyolefin that can be mentioned are polypropylenes. The polypropylene for films or extrusion coatings may be an isotactic, syndiotactic or atatic polypropylene or a mixture thereof. The polypropylene may be amorphous, partially crystalline or highly crystalline. Also block polymers or random copolymers of polypropylene may be employed. The average molar mass may be e.g. from less than 10,000 to 600,000 or higher. Also copolymers, such as ethylene/propylene-block or multiblock-copolymers and poly-blends such as caoutschouc modified polypropylene and of polypropylene may be employed. For example, ethylene/propylene-block copolymers may contain up to 50 wt. % polyethylenes such as e.g. high density polyethylene (HDPE).

The plastic films of the polyamide type contain e.g. polyamide 6, a homopolymeride of ε-caprolactam (polycaprolactam); polyamide 11, polyamide 12, a homopolymeride of ω-laurin-lactam (polylaurinlactam); polyamide 6.6, a homopolymer condensate of hexa-methylene-diamine and adipinic acid (poly-hexa-methylene-adipamide); polyamide 6.10, a homopolymer condensate of hexa-methylene-diamine and sebacinic acid (poly-hexa-methylene-seba-camide); polyamide 6.12, a homopolymer condensate of hexa-methylene-diamine and dodecandic acid (poly-hexa-methylene-dodecanamide) or polyamide 6-3-T, a homopolymer condensate of trimethyl-hexamethylene-diamine and terephthalic acid (poly-trimethyl-hexa-methylene-terephthalamide, and mixtures thereof. Preferred are polycaprolactams. Coextrud-ed layers of polyamides are to advantage non-stretched. The films of polyamides may be non-stretched or uniaxially or biaxally oriented. The plastic films of the polyamide type may be e.g. 8 to 50 μm thick, usefully 10 to 40 μm, preferably 15 to 25 μm thick.

The plastic layers of coextrusion coated, coextruded or extrusion laminated poly-amide/polypropylene is e.g. a prefabricated unit containing the two polymers. The plastic film of coextruded polyamide/polypropylene may e.g. have a thickness of 30 to 125 μm, usefully 50 to 90 μm and preferably 60 to 80 μm. The thickness of the polyamide layer in the coextrusion coated, coextruded or extrusion laminated polyamide/polypropylene film may make up e.g. 5 to 50% of the total thickness of the coextrusion coated, coextruded or extrusion laminated film, usefully 10 to 30% and preferably 15 to 25%.

A useful version is such that the plastic layer, layer c), exhibits a layer arrangement comprising superimposed coextrusion coated, coextruded and/or extrusion laminated first bonding agent/polyamide/bonding agent/polypropylene, where layer c) lies on the free side of the first bonding agent layer on the metal foil, layer b).

In a preferred version plastic layer, layer c), exhibits a layer arrangement comprising super-imposed, coextruded bonding agent and polyamide, extruded bonding agent and laminated polypropylene film, where layer c) lies over the free side of the coextruded bonding agent layer on the metal foil, layer b).

In a another preferred version plastic layer, layer c), exhibits a superimposed layer arrangement comprising laminate adhesive and laminate bonded, a polyamide/bonding agent/polypropylene film, where the layer c) lies on the laminate adhesive layer on the metal foil, layer b).

In another preferred version the plastic layer, layer c), exhibits a layer arrangement comprising, lying one over another, extruded first bonding agent, laminate bonded polyamide film, extruded bonding agent, laminate bonded polypropylene film, where the first extruded bonding agent layer lies on the metal foil, layer b).

In a further version the plastic layer, layer c), exhibits a layer arrangement comprising, superimposed on each other, coextrusion coated first bonding agent, polyamide, bonding agent and polypropylene, where the first layer of bonding agent lies on the metal foil, layer b).

For example, the plastic layer, layer c) may exhibit a layer arrangement of, superimposed, coextrusion coated, coextruded and/or extrusion laminated bonding agent of thickness 3 to 15 μm/polyamide of thickness 10 to 40 μm/bonding agent of thickness 3 to 15 μm/poly-propylene of thickness 30 to 70 μm.

The series of polyamide/polypropylene films may include other variants which result in steril-isable composite films according to the present invention, in which the composite film exhibits a layer structure containing superimposed one on top of the other or in sequence:
a) a first functional layer containing a plastic film of the following type viz., polyesters, polyamides or polyolefins or an extrusion layer of polyolefins or one or more layers of lacquer or print and lacquer layers or print layers and
b) a metal foil and
c) a plastic layer having a layer arrangement of coextrusion coated, coextruded and/or extrusion laminated polypropylene/polyamide/polypropylene.

Useful as layer c) is a plastic film having a series of layers of superimposed coextrusion coated or coextruded and/or extrusion laminated polypropylene/bonding agent/polyamide/bonding agent/polypropylene.

Preferred as layer c) is an arrangement of layers of superimposed laminate adhesive and laminate bonded a film of polypropylene/bonding agent/polyamide/bonding agent/poly-propylene film, where layer c) lies on the laminate adhesive on the metal foil, layer b).

Also preferred as layer c) is an arrangement of layers, superimposed on each other, of coextrusion coated polypropylene, bonding agent, polyamide, bonding agent and poly-propylene, where the first layer of polypropylene lies on the metal foil, layer b).

Preferred as layer c) is a plastic layer having an arrangement of layers comprising coextrusion coated , coextruded and/or extrusion laminated 10-20 μm thick polypropylene/3-15 μm thick bonding agent/10-40 μcm thick polyamide/3-15 μm thick bonding agent/30-70 μm thick polypropylene.

A bonding agent which is e.g. 3-15 μm thick may be provided between the plastic layer, layer c) and the metal foil, layer b). Instead of a bonding agent, for example if a prefabricated layer c) or a layer of polyamide or polypropylene is provided, layer c) in the form of a whole layer or the film belonging to layer c), may be laminate bonded to the metal foil, layer b), using a laminate adhesive.

The films of coextruded polyamide/polypropylene may be non stretched or may be uniaxially or biaxially oriented.

Examples of polypropylenes and polyamides in the plastic film of coextruded polyamide/polypropylene may be taken from the list presented above.

In the case of layers of e.g. coextruded polyamide/polypropylene, bonding is usually onto the inside i.e. the side facing the contents of a packaging container made from the composite film according to the invention. In that sense the polyamide layer faces the metal foil or is laminated onto the metal foil.

The present composite films may be sealed via the outer lying polyamide layer

The composite films here may be sealed by means of the outer lying polypropylene layer of the co-extruded film.

In some cases, in order to control the sealing properties further, one may deposit on the polypropylene, and on the other free side of the composite film—for example the lacquer coating or the polyester, polyamide or polyolefin film or the polyolefin layer—sealing layers such as sealing films, hot sealing lacquers or sealing lacquers e.g. on the basis of polyolefins such as polyethylenes, copolymers and terpolymers of ethylene with acrylic acid (EAA, ethyl acrylic acid) of ethylene with acrylic esters, such as methyl acrylate (EMA), ethyl acrylate (EEA) or butyl acrylate (EnBA), of ethylene with vinylacetates (EVA), of ethylene with methylacrylic acid (EMMA), of ethylene with ethyl acrylate and acrylic acid (EAEAA) or ionomer resins, alone or in mixture form, polypropylenes, and mixtures thereof, also poly-acrylates, PVC resins, polyvinyliden chlorides, EVA, polyalkylene-terephthalates, in particular of the A-PET type etc.

The free side, in particular the of the polyester film, may be coated with EVA (ethylene/vinyl alcohol copolymer) or with an amorphous polyester sealing layer of the A-PET type. Especially preferred are polypropylenes and polyethyleneterephthalates

The individual layers i.e. the first functional layer and thereby in particular the plastic film a) from the series of polyester films, or polyamide films, or polyolefin films or polyolefin layers facing the metal foil and/or the second functional layer (layer c) ) facing the metal foil and in some cases the individual layers of the functional layer, layer c), among themselves and any sealing films on the free side of the composite film may be joined to each other by means of a bonding agent and/or laminate adhesive.

Suitable laminate adhesives may be solvent-containing or solvent-free and water-containing. Examples of laminate adhesives are solvent-containing, solvent-free or aqueous acrylic adhesives or polyurethane adhesive systems. However, also adhesives that harden under the influence of radiated energy (e.g. ultra violet, electron beam radiation) may be employed. In view of the preferred application of the composite material in the field of foodstuff packaging, adhesive systems that are totally acceptable from the physiological standpoint are to be given preference. Aliphatic adhesive systems are particularly suitable.

For example, products based on maleic acid and modifiedpolypropylene or polyethylene may be employed as bonding agents.

The laminate adhesive may be deposited e.g. by casting, wiping, spraying, application from smooth rolls etc.

The laminate adhesive and the bonding agent may be employed in amounts e.g. of 0.5 to 10 g/m², preferably 1 to 8 g/m² and in particular 2 to 6 g/m². The laminate adhesives and the bonding agent may also be employed in amounts resulting in layers having a thickness e.g. of 0.1 μm, preferably 3.0 μm, up to 15 μm.

The surface of the metal foil may provide better adhesion properties for the adhesive or lacquer or for an extrusion layer by an appropriate pre-treatment (e.g. brushing, chromate treatment, ionising treatment, or treatment with ozone, flame or plasma). In order to assist and improve the bonding of the lacquer, bonding agents or laminate adhesives between the plastic films or the bonding of extruded layers, it is often useful to provide the film with adequate surface tension on the side facing the adhesive or the extrudate. The increase in surface tension may be achieved advantageously by an ionising, ozone, plasma, flame or corona pre-treatment.

It may also be advantageous to join the first and/or second functional layer to the metal foil, without laminate adhesive and/or bonding agent, only under the action of pressure and heat.

In one possible version e.g. the plastic film a) of the polyester or polyamide type may exhibit a counter image on the side facing the metal foil. A counter image is particularly suitable for transparent and translucent films. It is also possible to provide the polyester, polyamide or polyolefin film, or extrusion layer of polyolefins with a printed image on the outside and if desired to cover the image with a lacquer coating.

The composite films may exhibit, as a first functional layer a), one or more lacquer coatings or lacquer coatings and print layers on the outside or facing the outside viz., with respect to the container made from the film according to the invention. Print layers include in particular material deposited by a printing process over part or the whole of the surface.

Protective coatings, pre-coatings, print materials and if necessary covering layers that come into question are e.g.:

Systems based on solvents (1) or systems with water as solvent (2) or systems that are dried or hardened by ultra violet or another form of radiation (3). The lacquer pre-coatings or covering layers (1) dissolved in solvents may be lacquer coatings with binding agent based on polyacrylate, polymethylacrylate, polyester, epoxide, cellulose nitrate, polyvinyl-chloride-acetate, polyvinylbutyral or mixtures of these binding agents, hardened with melaminic resins, ureic resins, polyisocyanates polyazirides or mixtures of these, if desired used along with acids, amines, calcium compounds, tin compounds as hardening accelerators and silanes, titanium or zirconium chelates as additives to promote bonding.

The corresponding printing materials may be made up in a similar manner, or they are often made up using non-hardening resins e.g. polyvinylbutyral or cellulose nitrate.

Aqueous systems (2) contain additionally tensides in order to ensure solubility. Use may be made of printing materials and covering layers (3) hardening under the influence of ultra-violet and other forms of radiation may, be radical cross-linking printing materials and covering lacquer layers based on acrylates on conventional pre-coatings, as described above, print-ing materials that cross-link by a cationic mechanism, as described above, print pre-coating lacquers or UV- or radiation-hardening lacquer pre-coatings that cross-link by a cationic mechanism.

The lacquer layer or layers my be deposited by casting, spraying, wiping, deposition from a smooth roll etc., for example in each case in an amount of 0.5 to 10 g/m², in particular from 1.0 to 5 g/m².

If in addition to the lacquer coating or coatings or extrusion coatings, print layers or print layers alone are employed, then the printing of the composite film may be carried out using all known printing methods e.g. typographic, offset, flexo, screen, helio, and copper gravure printing. The choice of printing method to be employed depends on the desired quality of print, the prevailing technical aspects and on the number to be printed. It is possible to deposit single or multi-coloured layers of print on part or the whole of the surface area. Preferred is flexo-printing (also known as aniline or offset printing) and screen printing such as copper gravure printing, or helio-printing. The printing lies on the outward facing side of the composite material and e.g. in addition may have an overcoat of at least one further lacquer coating. For example, one, two, three or more lacquer coatings may be employed, the first lacquer coating lying on the metal foil or the pre-treated metal foil. In another version the printing may be deposited directly on the metal foil and if desired be covered by one, two, three or more lacquer layers. The last mentioned lacquer layers are, advantageously, transparent or translucent and act as protection for the printing. The printing may also be performed in several steps and at least one print layer covers the whole surface with the result that this total surface print layer or layers acts/act as a protective layer or layers. In another version the metal foil or pre-treated metal foil may have an overcoat of one or more lacquer layers. On top of this lacquer layer or layers comes whole area or partial area single or multi-coloured printing, which in some cases may be covered over with one or more lacquer layers, in particular transparent or translucent lacquer layers.

If desired the inner side of the composite may also be provided with a lacquer and/or printing.

The production of the composite film according to the invention may take place in a simple manner and in few process steps. The second functional layer c) of polypropylene/bonding agent/polyamide is produced e.g. by co-extrusion or extrusion laminating and prepared for further processing. The first functional layer a) is deposited onto one side of the metal foil in the form of a polyester film e.g. laminate bonded using a laminate adhesive, or as an extruion coating, or the lacquer layer or layers, the print layer or layers, or lacquer and print layers are deposited in a single or multi-stage lacquering process and/or printing process, or as extrusion coating and overlying print layers. Thereafter the second functional layer c) can be laminate bonded onto the side of the metal foil that is still free. The sequence in the laminate coating process or lacquer coating and printing may be performed in an analogous manner also in a different order.

Layer c) in the form of a plastic film with the structure polyamide/bonding agent/poly-propylene can be manufactured e.g. by coextrusion such as 3 layer blow-extrusion or 3 times extrusion laminating or by coextrusion coating. Such a film may be deposited on one side of the metal foil, layer b) e.g. using a bonding agent or, in particular, using a laminate adhesive. It is also possible to deposit layer c) directly onto the metal foil by coextrusion coating.

Layer c) in the form of a plastic film with the structure polypropylene/bonding agent/poly-polyamide/bonding agent/polypropylene can be manufactured e.g. by coextrusion such as 5 layer blow-extrusion or multiple e.g. 5 times extrusion laminating or by coextrusion coating. Such a film may be deposited on one side of the metal foil, layer b) e.g. using a bonding agent or, in particular, using a laminate adhesive. It is also possible to deposit layer c) directly onto the metal foil by coextrusion coating.

Another manner of manufacture may be such that e.g. a first coextrudate of bonding agent and polyamide is deposited on one side of the metal foil and a second coextrudate of bonding agent and polypropylene is deposited on the free side of the polyamide, whereby the poly-propylene then forms the free outer side.

Yet another method of manufacture is such that e.g. a first coextrudate of bonding agent and polyamide is deposited on one side of the metal foil, layer b), and, a polypropylene film is deposited as the outer lying layer on the free side of the polyamide by extrusion laminating a bonding agent.

Another method of manufacture is such that e.g. a first bonding agent, the polyamide, is deposited on one side of the metal foil, layer b), on the free side of the polyamide a second bonding agent and finally the propylene deposited one after the other by casting or extrusion, whereby the propylene forms the free outer side.

The present invention also relates to pouch type forms of packaging of a sterilisible composite film according to the present invention. Pouch type forms of packaging may be made e.g. from a piece of composite material by folding and sealing, or from two side pieces of the said composite material by—if desired folding and—sealing, or from a plurality of side pieces of the composite material by—if desired folding and—sealing. Typical pouches are flat pouches, self-standing pouches, pouches sealed at the edges, pouches of given volume, self-standing pouches of given volume, side-seam flat pouches, rigid-base pouches, or bags such as welded flat or folded bags etc. The pouch-type forms of packaging may be employed for contents such a foodstuffs for human consumption or for animals or for semi-luxury items all of which may be in lump form, or in pulpy, pasty, semi-fluid or fluid form. Other examples of applications for such pouches are cosmetics or substances for personal hygiene in pasty to fluid form. Other examples are pharmaceutical products or preparations for remedial pur-poses. The composite films according to the present invention can be sterilised without suffering delamination of the individual layers or loss of strength e.g. by a thermal treatment at 110 to 130° C., preferably 121° C., for 10 to 60 minutes, preferably 30 minutes.

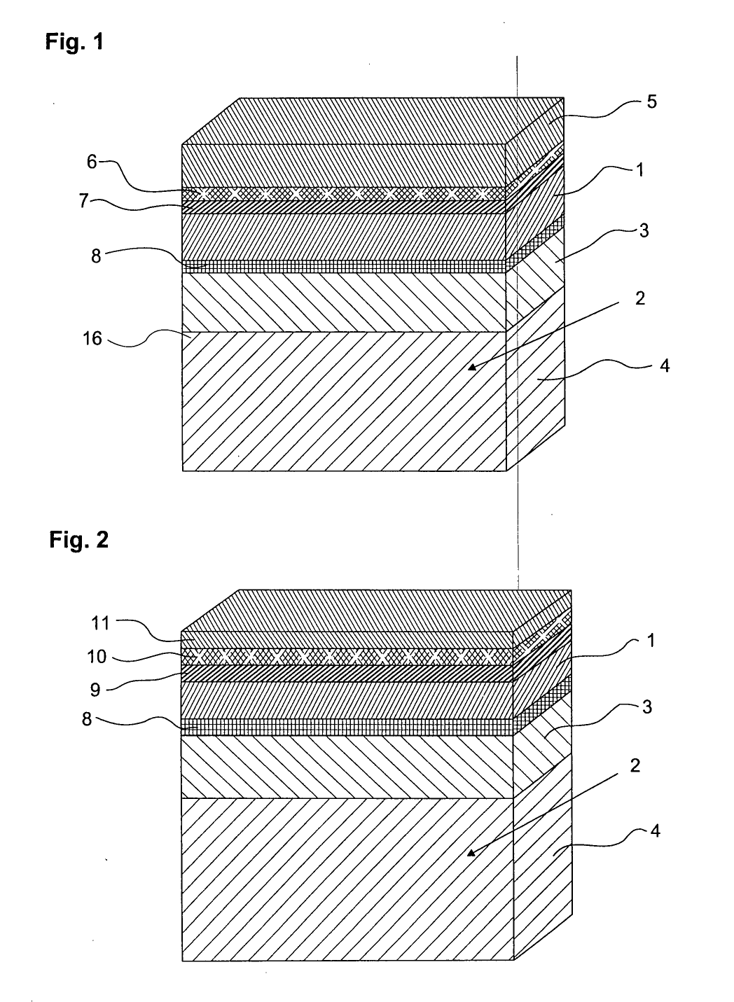

FIGS. 1 to 3 show schematically by way of example the make up of the composite film according to the invention.

The composite film shown in FIG. 1 features a metal foil 1. Laminate coated onto one side of the metal foil 1, by means of the laminate adhesive 7, is the first functional layer e.g. in the form of a PETP film 5. By way of example the PETP film 5 bears a counter-print 6. On the other side of the metal foil 1 is the second functional layer 2 in the form of a co-extrusion film comprising polyamide 3 and polypropylene 4, laminate bonded to the metal foil 1 by means of a laminate adhesive 8. When the composite film is in use, the polypropylene 4 of the co-extruded film 2 faces the contents of the packaging made from the composite film.

The composite film shown in FIG. 2 features a metal foil 1. On one side of the metal foil 1 is the first functional layer in the form of print and lacquer layers. Directly on the metal foil 1 is a pre-coating of lacquer 9, on top of this the surface print 10 and finally the protective lacquer 11. On the other side of the metal foil 1 is the second functional layer 2 in the form of a co-extrusion film of polyamide 3 and polypropylene 4 laminate bonded to the foil 1 by means of a laminate adhesive 8. Also in this application of the composite film the poly-propylene 4 of the co-extrudate 2 faces the contents of the packaging made from the composite film.

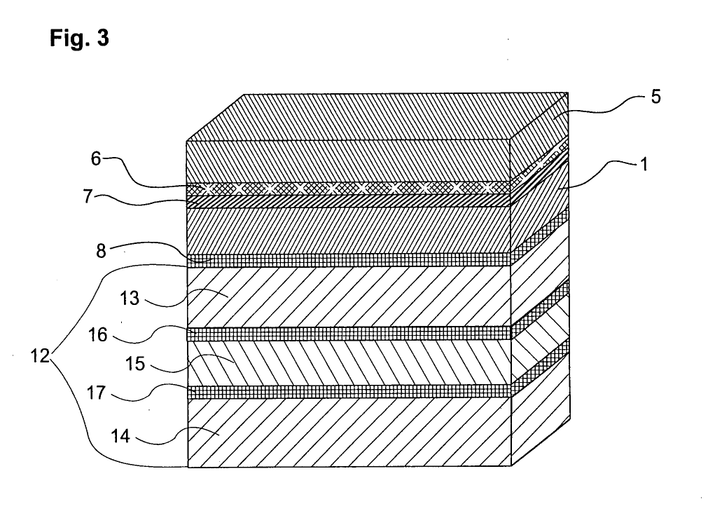

The composite film shown in FIG. 3 exhibits a metal foil 1. The first functional layer in the form e.g. of a PETP film 5 is laminate bonded to one side of the metal foil 1 by means of the laminating adhesive 7.

By way of example the PETP film 5 bears a counter-print 6. On the other side of the metal foil 1 is the second functional layer 2 in the form of a plastic film 12 with a layer arrangement of coextruded and/or extrusion laminated polypropylene 13/bonding agent 16/polyamide 15/bonding agent 17/polypropylene 14 laminate bonded by way of a laminate adhesive 8.

1. Sterilisible composite film containing a barrier layer that is impermeable to water vapor and gases in the form of a metal foil, and on both sides of the barrier layer at least one functional layer,
the composite film exhibits a layer structure containing one on top of the other:
a) a first functional layer containing a plastic film of the polyester, polyamide or poly-olefin type or an extrusion layer of polyolefins or one or more lacquer layers or print and lacquer layers or print layers and
(b) a metal foil and
(c) a second functional layer in the form of a plastic film of the coextrusion coated, coextruded and/or extrusion laminated polyamide/polypropylene film type.

2. Sterilisible composite film according to claim 1, wherein the plastic layer, layer c), exhibits a layer arrangement comprising coextrusion coated, coextruded and/or extrusion laminated bonding agent/polyamide/bonding agent/polypropylene, where layer c) lies over the free surface of the first layer of bonding agent on the metal foil, layer b).

3. Sterilisible composite film according to claim 2, wherein the plastic layer, layer c), exhibits a layer type structure with one layer superimposed over the other, comprising coextruded bonding agent and polyamide and extruded bonding agent and laminate bonded polypropylene film, whereby layer c) lies on the free side of the coextruded bonding agent layer on the metal foil, layer b).

4. Sterilisible composite film according to claim 1, wherein the plastic layer, layer c), exhibits a layer type structure with one layer superimposed over the other, comprising laminate adhesive and laminate bonded a polyamide/bonding agent/poly-propylene film, whereby the laminate adhesive layer lies on the metal foil, layer b).

5. Sterilisible composite film according to claim 2, wherein the plastic layer, layer c), exhibits a layer type structure with one layer superimposed over the other, comprising bonding agent, laminate bonded polyamide film, extruded bonding agent and laminate bonded polypropylene film, whereby the first extruded bonding agent layer lies on the metal foil, layer b).

6. Sterilisible composite film according to claim 2, wherein the plastic layer, layer c) exhibits a layer type structure with one layer superimposed over the other, comprising coextrusion coated bonding agent, polyamide, bonding agent and poly-propylene, whereby the first bonding agent layer lies on the metal foil, layer b).

7. Sterilisible composite film according to claim 2, wherein the plastic layer, layer c) exhibits a layer type structure with one layer superimposed over the other, comprising coextrusion, coextruded and/or extrusion laminated bonding agent with a thickness of 3 to 15 μm/polyamide with a thickness of 10 to 40 μm/bonding agent with a thickness of 3 to 15 μm/polypropylene with a thickness of 30 to 70 μm.

8. Sterilisible composite film according to claim 1, wherein the composite film exhibits a layer type structure containing in sequence:
a) a first functional layer containing a plastic film of the polyester, polyamide or poly-olefin type or an extrusion layer of polyolefins or one or more lacquer layers or print and lacquer layers or print layers and
(b) a metal foil and
(c) a plastic layer having a layer type of structure comprising coextrusion coated, coextruded and/or extrusion laminated polypropylene/polyamide/polypropylene.

9. Sterilisible composite film according to claim 8, wherein the layer c) is a plastic film exhibiting a layer type structure comprising coextrusion coated, coextruded and/or extrusion laminated polypropylene/bonding agent/polyamide/bond-ing agent/polypropylene.

10. Sterilisible composite film according to claim 8, wherein the plastic layer, layer c) exhibits a layer type structure with one layer superimposed over the other, comprising laminate adhesive and laminate bonded a film of polypropylene/bonding agent/polyamide/bonding agent/polypropylene, whereby layer c) lies on the laminate adhesive layer on the metal foil, layer b).

11. Sterilisible composite film according to claim 8, wherein the plastic layer, layer c) exhibits a layer type structure with one layer superimposed over the other, comprising coextrusion coated polypropylene, bonding agent, polyamide, bonding agent and polypropylene, whereby the first polypropylene layer lies on the metal foil, layer b).

12. Sterilisible composite film according to claim 8, wherein layer c) is a plastic layer with a layer structure of coextrusion coated or coextruded and/or extrusion laminated polypropylene with a thickness of 10 to 20 μm/bonding agent with a thickness of 3 to 15 μm/polyamide with a thickness of 10 to 40 μm/bonding agent with a thickness of 3 to 15 μm/polypropylene with a thickness of 30 to 70 μm.

13. Sterilisible composite film according to claim 1, wherein between the plastic layer, layer c), and the metal foil, layer b), a laminate adhesive is provided in an amount from 0.5 to 10 g/m², or a bonding agent.

14. A pouch type of packaging made from a sterilisible composite film according to claim 1.

15. A method comprising making the sterilizible composite film of claim 1.
